(19) United States
(12) Patent Application Publication
(10) Pub. No.: US 2008/0040167 A1
(43) Pub. Date: Feb. 14, 2008

(54) BOOKING SYSTEM AND METHOD

(75) Inventors: Jonathan Ackerman, Auckland (NZ); Liz Hardwick-Smith, Auckland (NZ)

Correspondence Address: KNOBBE MARTENS OLSON & BEAR LLP, 2040 MAIN STREET, FOURTEENTH FLOOR, IRVINE, CA, 92614, US

(73) Assignee: AIR NEW ZEALAND LIMITED, Auckland (NZ)

(21) Appl. No.: 11/697,258

(22) Filed: Apr. 5, 2007

Related U.S. Application Data
(60) Provisional application No. 60/789,847, filed on Apr. 6, 2006.

(30) Foreign Application Priority Data
Apr. 5, 2006 (NZ) 546427

(51) Int. Cl. G06Q 10/00; G06F 17/30

(52) U.S. Cl. 705/5

(57) ABSTRACT

A method and airline booking system for converting fare rules into computer code for efficient fare validation and/or for calculation of sundry costs is disclosed. In one embodiment, the method includes converting fare rules into computer code and storing the computer code. The method also includes receiving flight criteria from a user and identifying candidate fares satisfying the flight criteria received from the user. The method further includes retrieving and executing the computer code to determine which of the candidate fares satisfy the fare rules embodied by the computer code.

### RELATED APPLICATIONS

This application claims priority under 35 U.S.C. § 119(e) from provisional application No. 60/789,847 filed on Apr. 6, 2006, which is hereby incorporated by reference.

### BACKGROUND OF THE INVENTION

1. Field of the Invention

The present invention relates to booking systems for the airline industry.

2. Description of the Related Technology

Traditionally, when a customer wanted to book airline flights to travel to and from a destination, they visited a travel agent who assisted them in researching the availability and cost of flights. The customer then booked the flights through the travel agent and received tickets some time later when processing was complete.

Due to the advent of the internet many airlines now provide online booking systems that enable customers to access flight information directly from their own computers over the internet. Such systems enable customers to check the cost and availability of flights, and book flights which meet their requirements.

### SUMMARY OF CERTAIN INVENTIVE ASPECTS

One aspect of the present invention provides modifications to existing airline booking systems which improve the service provided to customers. Another aspect of the invention provides an indication of sundry costs when displaying flight costs. Another aspect of the invention processes fare rules more efficiently.

Another aspect of the present invention may provide a method of determining fares for display to a user using a booking system comprising: converting fare rules into computer code, storing the computer code, receiving flight criteria from a user, identifying candidate fares satisfying the flight criteria received from the user, and retrieving and executing the computer code to determine which of the candidate fares satisfy the fare rules embodied by the computer code.

In one embodiment, the fares comprise one or more associated costs for purchasing/booking a journey. In one embodiment, the converting fare rules into computer code comprises: retrieving data defining fare rules, generating interim code that defines the fare rules, from the interim code, generating the computer code, the computer code defining the fare rules.

In one embodiment, the computer code is compiled. In one embodiment, the executing the computer code to determine which of the candidate fares satisfy the fare rules embodied by the computer code comprises: selecting a candidate fare identifying a fare rule to be applied to the selected candidate fare, obtain and execute computer code defining the fare rule, obtaining information for applying the fare rule, executing a validator specified by the computer code, the validator utilizing the obtained information on the candidate fare to determine whether or not the candidate fare satisfies a fare rule defined by the computer code.

In one embodiment, each fare ruled defined by the computer code has two or more categories, wherein a validator applies each category and further comprising: executing one or more further validators specified by the computer code, the one or more further validators utilizing the obtained information on the candidate fare to determine whether or not the candidate fare satisfies one or more fare rules defined by the computer code, and identifying the candidate fare as one that is valid.

In one embodiment, the method comprises: selecting a further candidate fare, retrieving information on the further candidate fare, executing one or more validators specified by the computer code, each validator utilizing the obtained information on the further candidate fare to determine whether or not the candidate fare satisfies one or more fare rules defined by the computer code, identifying the further candidate fare as one that is valid.

In one embodiment, the candidate fares relate a constructed fare, and if all candidate fares are valid, the constructed fare is flagged as one possible to present to a user.

In one embodiment, the interim code defines one or more fares rules, and contains identifiers that identify portions of the interim code that specify a fare rule and aspects of that fare rule, the generating the computer code from the interim code, comprises: parsing the interim code, generating a hierarchy of code generators relating to the portions of the interim code identified by the identifiers, executing each code generator to generate computer code relating to the portion of the interim code to which the code generator relates, wherein each code generator at a higher level in the hierarchy utilizes code generated by a code generator directly below in the hierarchy.

In one embodiment, the interim code defines one or more fares rules, and contains identifiers that identify portions of the interim code that specify a fare rule and aspects of that fare rule, the generating the computer code from the interim code uses one or more code generation processes to, each process generating a subset of the computer code from a subset of the interim code, wherein each code generation process is assigned a logical position in a hierarchy, and wherein the computer code generated by a lower code generation process in the hierarchy is passed to a higher code generation process in the hierarchy, wherein when generating computer code, the higher code generation process utilizes the code generated by the lower code generation process.

In one embodiment, interim code data defines fare rules comprising a number of categories, each of which comprises criteria and wherein a code generation process is used for each category, which can extract data from the interim code relating to that category, and generate computer code from that data.

In one embodiment, the hierarchy is a tree structure of code generation processes, and the tree structure is traversed in order to generate code with the code generation processes.

Another aspect of the present invention provides a method of generating code defining fare rules for determining fares available for display to a user using a booking system comprising: retrieving data defining fare rules, generating interim code that defines the fare rules, wherein the interim code defines one or more fares rules, and contains identifiers that identify portions of the interim code that specify a fare rule and aspects of that fare rule, parsing the interim code, generating a hierarchy of code generators relating to the portions of the interim code identified by the identifiers, executing each code generator to generate computer code relating to the portion of the interim code to which the code generator relates, wherein each code generator at a higher level in the hierarchy utilizes code generated by a code generator directly below in the hierarchy.

In one embodiment, the obtained information is one or more of: journey option(s) related to the candidate fare, and itinerary information relating to the candidate fare. In one embodiment, the method is executed at least partially in an airline booking system. In one embodiment, a candidate fare is or forms part of a fare construction.

Another aspect of the present invention provides a method of identifying and presenting fares to a user, the method comprising: receiving flight criteria specified by a user, receiving computer code from a database, the computer code being generated from fare rules to embody the fare rules, selecting candidate fares satisfying the flight criteria received from the user, executing the computer code to determine which of the candidate fares that satisfy the fare rules embodied by the computer code, and presenting the relevant candidate fares that satisfy the fare rules to a user.

Another aspect of the present invention provides a computer system adapted to generate code defining fare rules for determining fares available for display to a user using a booking system, the computer system comprising: a database containing data defining fare rules, a first code generator module connected to the database and adapted to retrieve data from the database and generate interim code defining fare rules, a second code generator module connected to retrieve interim code from the first code generator, the second code generator adapted to generate computer code from the interim code, the computer code defining the fare rules.

In one embodiment, the interim code defines one or more fares rules, and contains identifiers that identify portions of the interim code that specify a fare rule and aspects of that fare rule, and wherein the second code generator module is adapted to: parse the interim code, generate a hierarchy of code generators relating to the portions of the interim code identified by the identifiers, operate each code generator to generate computer code relating to the portion of the interim code to which the code generator relates, wherein each code generator at a higher level in the hierarchy utilizes code generated by a code generator directly below in the hierarchy.

In one embodiment, the interim code defines one or more fares rules, and contains identifiers that identify portions of the interim code that specify a fare rule and aspects of that fare rule, and wherein the second code generator module comprises one or more code generators, each code generator being adapted to generate a subset of the computer code from a subset of the interim code, wherein each code generator is assigned a logical position in a hierarchy, and wherein the computer code generated by a lower code generator in the hierarchy is passed to a higher code generator in the hierarchy, wherein when generating computer code, the higher code generator utilizes the code generated by the lower code generator.

In one embodiment, interim code data defines fare rules comprising a number of categories, each of which comprises criteria and wherein the second code generator module comprises a code generator for each category, each of which can extract data from the interim code relating to that category, and generate computer code from that data.

In one embodiment, the hierarchy is a tree structure of code generators, and the tree structure is traversed in order to generate code with the code generators.

In one embodiment, the computer code is stored in the database and the computer system further comprises a search engine connected to the database, wherein the search engine adapted to receive flight criteria specified by a user and identify candidate fares satisfying the flight criteria, and wherein the search engine can execute the computer code to determine which of the candidate fares satisfy the fare rules embodied by the computer code.

In one embodiment, the search engine comprises one or more validators to execute the computer code to determine which of the candidate fares satisfy the fare rules embodied by the computer code, the search engine is adapted to: select a candidate fare based on received user criteria, identify a fare rule to be applied to the selected candidate fare, obtain and execute the computer code defining the fare rule, obtain information for applying the fare rule, execute one or more validators specified by the computer code, each validator utilizing the obtained information on the candidate fare to determine whether or not the candidate fare satisfies a fare rule defined by the computer code.

In one embodiment, the fares comprise one or more associated costs for purchasing/booking a journey. In one embodiment, the computer code is compiled. The interim code may be a markup language. The computer code may be java code. The computer system may be integrated with an airline booking system. In one embodiment, a candidate fare is or forms part of a fare construction.

Another aspect of the present invention provides a booking system comprising a computer system adapted to receive flight criteria from a user, the computer system comprising a processor for converting fare rules into computer code, a store for storing the computer code, and a computer program running on the computer system that operates the computer system to: select candidate fares satisfying the flight criteria received from the user, and retrieving and executing the computer code to determine which of the candidate fares that satisfy the fare rules embodied by the computer code.

Another aspect of the present invention provides a method of providing sundry costs to a user operating a booking system comprising: receiving input specifying flight criteria from a user, identifying fares satisfying the flight criteria, calculating sundry costs for a journey from sundry costs data retrieved from a database, displaying information identifying the journeys and associated fares on a first sub-portion of a user interface and displaying the sundry costs for the journey on a second sub-portion of the user interface, receiving input selecting another journey, and updating the second sub-portion of the user interface to display the sundry costs for the selected candidate fare.

In one embodiment, updating the second sub-portion of the user interface to display the sundry costs for the selected journey comprises calculating sundry costs related to the selected journey from data retrieved from the database.

In one embodiment, the sundry costs can be one or more of taxes, levies and surcharges. In one embodiment, the method further comprises displaying a total journey price comprising the associated fare for a selected journey and the displayed sundry costs for that journey.

In one embodiment, when updating the second sub-portion of the user interface to display the sundry costs for the selected journey, the method further comprises updating the user interface to display a total cost comprising the fare associated with a selected journey and the displayed sundry costs for that journey. In one embodiment, the updating the database with data for calculating sundry costs.

Another aspect of the present invention provides a booking system comprising: a computer system adapted to receive flight criteria from a user, one or more databases containing fare information and data for calculating sundry costs, a search engine adapted to identify fares satisfying the flight criteria received from the user, a user interface adapted to display those fares to the user, wherein the user interface is adapted to display information identifying a journey and associated fares on a first sub-portion of a user interface and displaying the sundry costs on a second sub-portion of the user interface, and wherein the computer system is adapted to receive input specifying a selected fare displayed on the first sub-portions and the user interface is adapted to update the second sub-portion of the user interface to display the sundry costs for the journey associated with the selected fare.

In one embodiment, updating the second sub-portion of the user interface to display the sundry costs for the journey associated with the selected fare comprises the search engine calculating sundry costs related to the journey from data retrieved from the database.

In one embodiment, the sundry costs can be one or more of taxes, levies and surcharges. In one embodiment, the user interface is further adapted to display a total journey price comprising the fare associated with a selected journey and the displayed sundry costs for that journey.

In one embodiment, when updating the second sub-portion of the user interface to display the sundry costs for the selected journey, the user interface is further adapted to update the user interface to display a total journey price comprising the fare associated with a selected journey and the displayed sundry costs for that fare.

Another aspect of the present invention provides a booking system comprising a computer system for receiving flight criteria from a user, a computer program for selecting all fares satisfying the flight criteria received from the user, a user interface for displaying those fares to the user, and for displaying for at least one fare, the cost of the flight associated with the fare and any sundry costs, a processor adapted to receive an input identifying another fare, obtain sundry costs for that fare and transfer the sundry costs to the user interface, wherein user interface is updated to display the sundry costs.

Still another aspect of the present invention provides a user interface for a booking system comprising: a portion adapted to display fares to a user that satisfy flight criteria received from the user, the portion comprising a sub-portion adapted to display the cost of the flight associated with the fare and another sub-portion adapted to display sundry costs, wherein the user interface is adapted to display for at least one fare, the cost of the flight associated with the fare and any sundry costs in the respective sub-portions, wherein the sub-portion adapted to display sundry costs can be updated with new sundry costs independently from other sub-portions of the user interface.

Still another aspect of the present invention provides a method of displaying fares to a customer using a booking system including: receiving flight criteria from a customer, determining all fares satisfying the flight criteria received from the customer, displaying those fares to the customer via a user interface, including for at least one fare, the cost of the flight associated with the fare and any sundry costs.

Yet another aspect of the present invention provides a method of providing sundry costs to a user of a booking system comprising: maintaining a database with sundry cost data, receiving a request for sundry costs for a journey, obtaining sundry cost data from the database, calculating sundry costs using the sundry cost data and a rules engine, and presenting the sundry costs to a user.

Described in this specification but not claimed is a booking system including: a computer system for receiving flight criteria from a customer, a computer program for selecting all fares satisfying the flight criteria received from the customer, a user interface for displaying those fares to the customer, wherein the user interface displays at least two tabs, wherein one tab includes the fares for a first class and the other tab displays the fares for a second class.

Described in this specification but not claimed is an interface for booking system including: a first tab for displaying fares to a customer that satisfy flight criteria received from the customer, and at least one further tab for displaying fares to a customer relating to another class.

Described in this specification but not claimed is a method including: receiving flight criteria from a customer, selecting all fares satisfying the flight criteria received from the customer, displaying those fares to the customer in a tab in a user interface, and further displaying at least one more tab, wherein the tab includes the fares for another class.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting

### BRIEF DESCRIPTION OF THE DRAWINGS

Embodiments of the invention will be described with reference to the drawings.

FIG. 1 is a block diagram showing the architecture of a booking system.

FIG. 2 is a flow chart showing operation of the booking system.

FIG. 3 is a block diagram showing the architecture of a fare rules maintenance system that generates fare rules for use by the booking system.

FIGS. 4a, 4b is a flow chart showing the fare rule generation process.

FIG. 4c is a flow chart showing the fare rule application process.

FIG. 5 shows the code generation logical hierarchy.

FIG. 6 is a flow chart showing how the customer obtains taxes and levies for a flight.

FIGS. 7a to 7c are screen shots of the user interface displaying flight fares including taxes and levies.

FIG. 8 is a block diagram showing the taxes and levies calculation application and its interrelationship with the webserver and client application.

FIG. 9 is a flow diagram showing the taxes and levies calculation process.

FIG. 10 is a process diagram showing how the booking system obtains taxes and levies for display to a customer.

FIGS. 11a to 11c are screen shots of the user interface displaying fares for different classes in different tabs.

Appendix A show XML code for fare rules.

Appendix B shows code generated from the XML code.

### DETAILED DESCRIPTION OF CERTAIN INVENTIVE EMBODIMENTS

Overview of Booking System

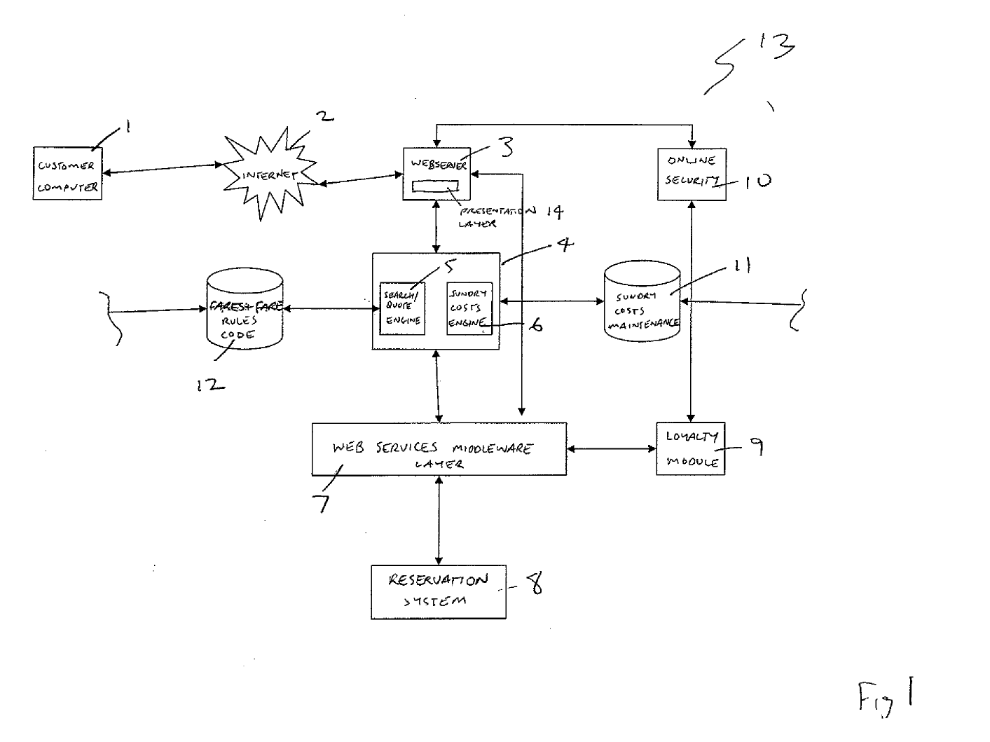

FIG. 1 shows an overview of an internet accessed booking system 13 according to one embodiment of the invention which implements functionality according to the invention. The system is accessed by a customer via a computer 1 connected to the internet 2. The system might comprise several interconnected computer sub-systems that might reside at the same or different physical locations. A web server 3 hosts a website, which includes a presentation layer 14 for enabling the user to access the booking system 13 via their computer 1. The presentation layer 14 includes among other things a graphical user interface for displaying information to a user over the internet and retrieving information from a customer. The web server 3 also includes back end applications for transferral of information between the web server and various other components of the system. The website and web server act as a conduit that transfers information between the customer computer 1 and the booking system 13.

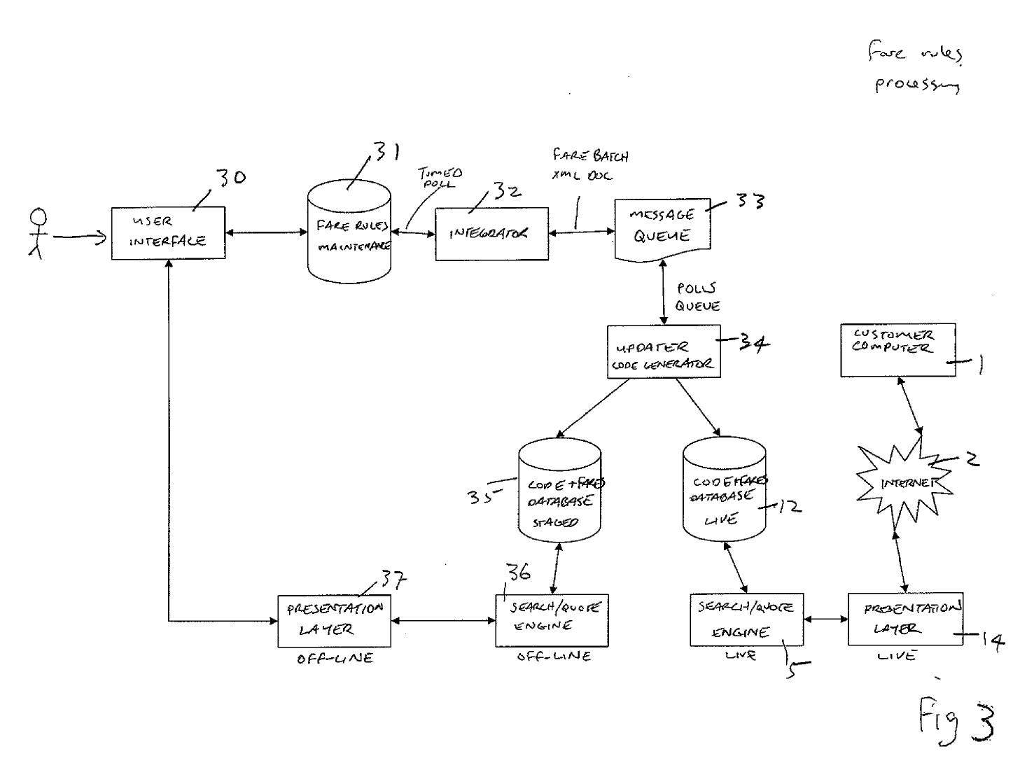

The web server 3 is connected to a computer system 4 which runs a search/quote engine and a summary costs engine. The search/quote engine 5 is adapted to receive user entered information from the web server 3 and utilize this information to obtain information on scheduled airplane flights, available seats on those flights and the respective costs for those flights which meet the customers requirements in accordance with their criteria entered. The term “fare” will be used to generally refer a cost associated with booking or purchasing a journey and associated service class on a flight. A journey might correspond to several flights that will get a customer to their destination (and back again if necessary). The journey is the set of flights which that transport the customer to their desired location. The term “flight” is used generally to indicate a seat available for purchase or booking on a particular scheduled airplane flight. The search/quote engine has access to a database 12 containing generated code relating to fare rules implemented by the airline. This will be described in detail later with reference to FIGS. 3-5.

The sundry costs engine 6 calculates the required sundry costs (such as taxes, levies and/or surcharges) associated with the flights that are returned by the search/quote engine. These sundry costs need to be added to the cost of the flight itself, to provide a total cost for a particular fare. The search/quote engine 5 and sundry costs engine 6 will be described in further detail later.

The search/quote engine 5 accesses a reservation system 8 via an middleware interface 7. The middleware acts as an interface between the internet/web side of the system 13 and the reservation system 8 which is maintained and operated by the airline or other provider of the flights. The reservation system holds information relating to flights provided by the airline, the various seat allocations for those flights along with associated availabilities, times, costs and the like. The system also allows for ticketing and seat management, and also is the definitive record of bookings of the available flights. Those skilled in the art will understand the purpose and make up of the reservation system and it need not be explained in further detail here.

Also provided in the system is a loyalty module 9 for recording the accumulation of loyalty points in relation to bookings, and also the redemption of loyalty points for bookings. An online services identity module 10 connected with both the internet and the loyalty module provides a security layer to ensure the redemption of loyalty points occurs only to authorised customers. This aspect of the system will also be understood by those skilled in the art.

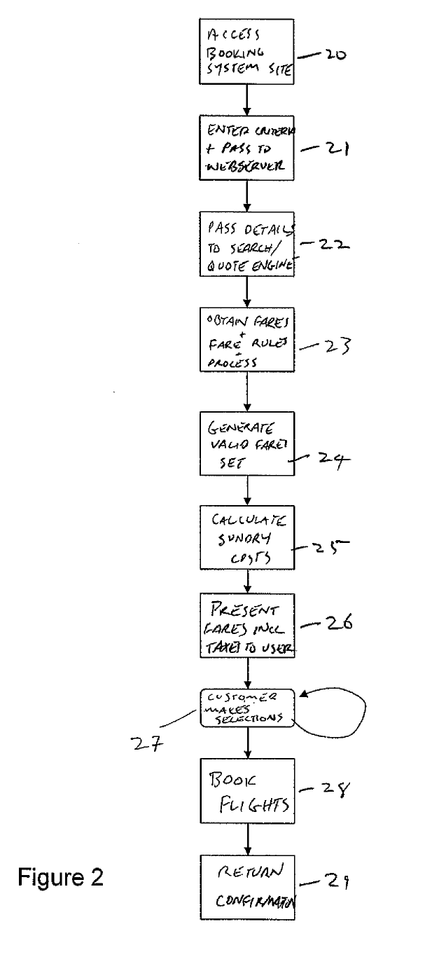

A brief overview of how the system operates will be provided with reference to FIG. 2. A customer who wishes to investigate available flights and their costs with the intention of booking flights to and from a destination can access a booking system, step 20, over the internet via their PC 1. Once they have accessed the website the web server provides a graphical user interface which asks for required information to enable the system to return possible flights and their costs, step 21. This information will include for example, the starting point and destination of the desired journey, the preferred dates of travel, number of travelers, the class of travel and any other criteria for indicating the customer requirements. The presentation layer 14 of the website hosted on the web server 3 then passes the information to the search/quote engine 5, step 22. The search/quote engine obtains flight availability from the reservation system 8 and fare rule information from fare rules database 12, step 23, and processes this information to generate a set of possible fares (that is, available flights and associated costs) that meet the customer's search criteria. In particular, it processes each fare in turn, and if it meets the fare rules, step 24, it is added to a set of fares for presentation to the customer, otherwise it is discarded. This process will be described further in detail with reference to FIGS. 3-5.

The sundry costs engine 6 then calculates the taxes, levies and other surcharges relating to those flights, step 25, and this information is all provided to the web server 3 which displays the information, step 26, using the presentation layer 14. The system then waits, step 27, and a user can then select a desired flight and proceed with booking the flight, step 28. The customer then enters required details including their name address and the like and also payment details, such as a credit card number. This is passed from the presentation layer to the reservation system 8 via the middleware layer 7. The reservation system 8 then books the selected flights and confirmation is provided back to the customer, step 29, via the web interface. Should the customer wish to accumulate or redeem loyalty points, they enter their identification and authorisation details on the online services identity module, and then the loyalty module processes the loyalty points as required.

Search/Quote Engine for Obtaining Fares and Applying Fare Rules

The search/quote engine 5 will be described in further detail. In general, the engine 5 receives flight criteria from the customer via the web server and uses this to construct fares that meet the criteria. In particular, the engine 5 retrieves flight availability data meeting the requirements from the reservation system 8, and uses this data to construct combinations of flights (fare constructions) that could carry the customer to and from their destination in accordance with their requirements. The application also retrieves from the reservation system 8 availabilities for those flight constructions. The fares are retrieved from database 12 via the search/quote engine 5. This results in fare constructions, where each fare construction comprises one or more available flights meeting the customer's criteria, along with the associated cost for those flights. The manner in which fares are constructed and the processes required for doing are known to those skilled in this area of technology and need not be described further here.

This process produces a set of constructed fares which meet the criteria of the customer's search. While a constructed fare might relate to an available flight, the airline has fare rules that determine whether or not a particular fare is available under particular circumstances, and therefore whether it can be offered for sale to a customer under those circumstances. For example, a particular fare might only be offered during a specific period, so cannot be offered to the customer if they wish to travel outside this period. A large number of such fare rules exist. The use of fare rules in this manner is well known to those in the airline industry.

Therefore, the search/quote engine 5 then needs to determine which of those fares in the set of constructed fares can be validly offered and therefore presented to the customer. To do so the search/quote engine 5 processes each constructed fare to determine which of the fares meet the fare rules under the particular circumstances and can be validly offered for sale and should be passed to the customer. Once each constructed fare has been processed in this manner, the set of valid fares is passed to the web server 3 for presentation to the customer. The database 12 accessed by the search/quote engine includes generated code which is compiled by the search/quote engine 5 and is executed to process the constructed fares in accordance with the fare rules.

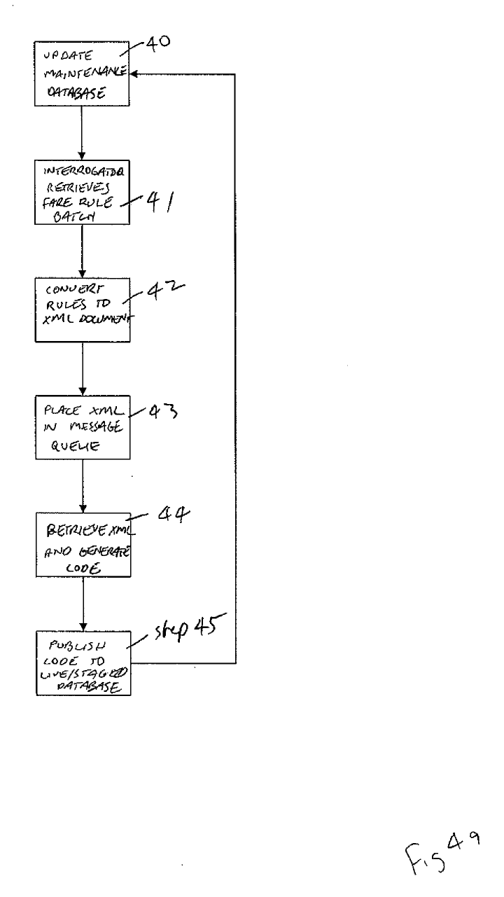

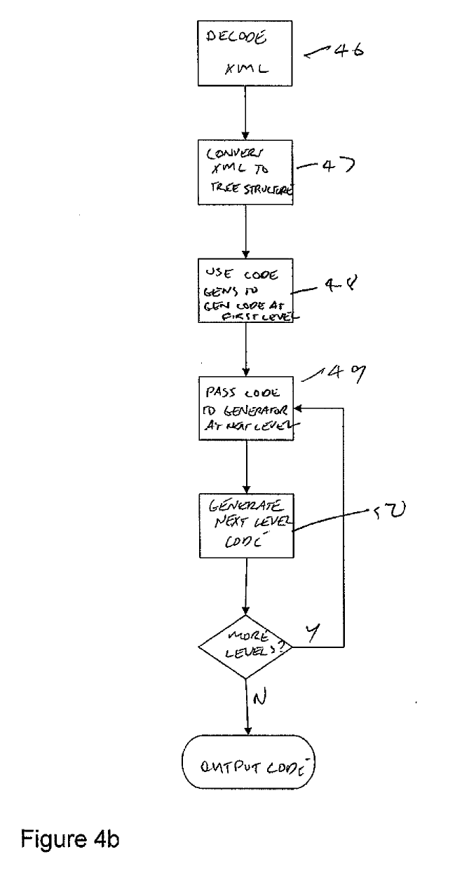

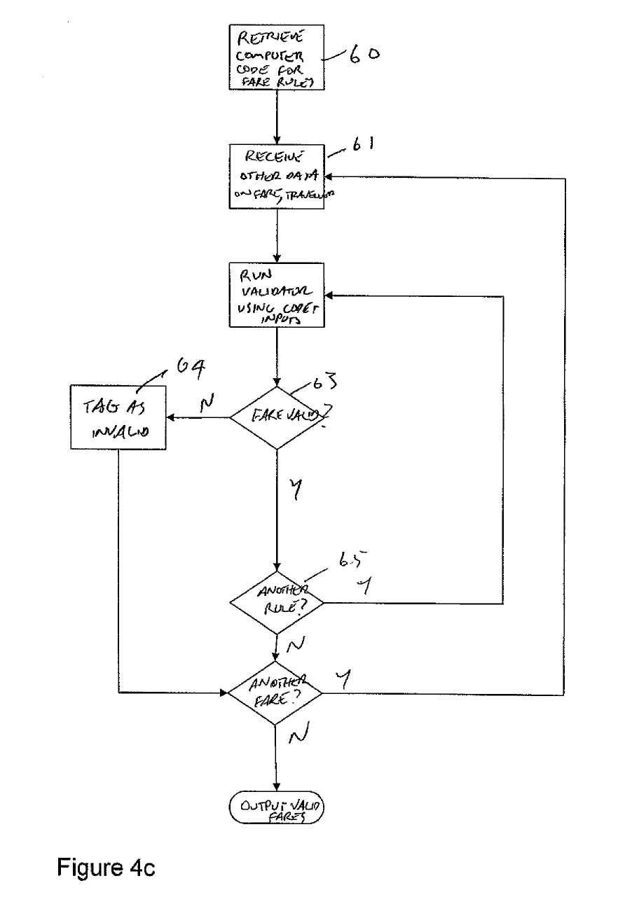

The manner in which the computer data is generated for the database will be described with reference to FIGS. 3 and 4a. As described above, the airline generates and maintains rules which determine whether a fare on a flight is valid for a particular set of conditions. For example, a particular fare associated with a flight may only be valid during a particular season or in combination with another fare. A particular fare associated with a flight has a set of categories which it must satisfy. The categories are determined by the airline industry and each category contains a number of criteria that must be met by a fare in order to satisfy the category. The airline may determine the particular criteria under any category, and also can stipulate which particular fares associated with flights have to satisfy which categories. The categories are generally industry standard. The airline continually updates 40 these criteria and through a graphical user interface 30 maintains them on a maintenance database 31 containing the fare rules and also batches of updated rules which are ready for publication.

An integrator 32 is coupled to the maintenance database 31 and when a batch is ready for publication it extracts the fare rules contained therein step 41. The integrator 32 then converts the batch of fare rules into an interim code, which can be in a markup language (such as XML) or another suitable document or code type step 42. The XML document which defines the fare rules is then placed in a message queue 33 which is polled by an updater module 34, step 43. Upon polling, the updater retrieves any XML documents in the queue step 44. This system provides an asynchronous transfer of information which prevents corruption of data if there is a failure in connections between components of the system at any point. The updater 34 generates code from the XML document, the computer code providing code for compilation and execution by the search/quote engine 5 as described above. The computer code can be any suitable code, such as Java code. The code embodies the fare rules in a way that enables the search/quote engine 5 to efficiently apply fare rules to fares. The updater then provides the code to a staged database 35, step 45 and subsequently the live database 12 after testing. The staged database is offline and can be accessed by system maintenance personnel by an offline presentation layer 37 and quote engine 38 to test the data and ensure that it works correctly. The live database 12 can be accessed by the presentation layer 14 and the quote engine 5 of the booking system 13 and is therefore used in processing queries for a customer.

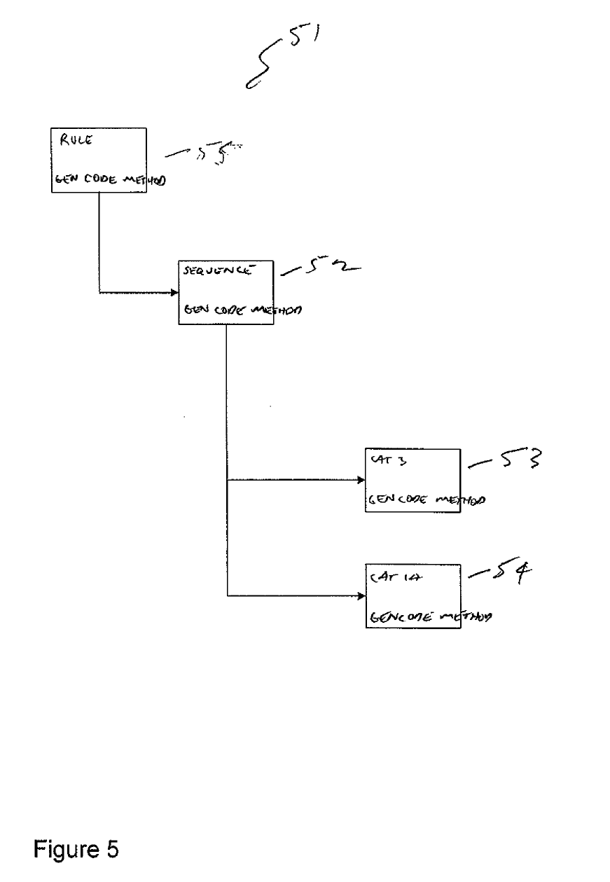

The manner in which the updater generates code from the XML document will be described with reference to FIGS. 4c, 5. A simplified example of some XML code which defines the fare rules contained in a fare batch that has been extracted from the maintenance database is as follows:

<fare batch>

<rule id=“5001”>

<sequence>

<fare basis>TAM1Y</fare basis>
<origin>NZ</origin>
<dest>US</dest>
<category 3>

<start date>1DEC</start date>
<end date>31DEC</end date>

</category 3>

</sequence>

</rule>

</fare batch>

The code that is generated in respect of the XML document by the updater 34 is shown below. This code being used by the search/quote engine 5 to compile and execute a processing means to determine if fares are valid or not.

If (fare basis =”TAM1Y” and flying “NZ” to “US”)

(if not

Validate Cat 3 (“1DEC”,”31DEC”)
Return false

)
Return true

Each fare batch contains a number of rules identified by a unique ID of which one is shown above. Each rule is an identification number that is associated with a particular fare, as described above. The rule stipulates which categories must be met by the fare in order to be valid. The next portion of the XML document includes a sequence which specifies the fare basis and the origin and destination ports for the flight. The next portion of the fare batch states the category or categories associated with the rule along with criteria that must be satisfied in order to meet the category requirement. For example, as shown above, the category 3 requires the start date and the end date of the flight to be between 1 December and 31 December. It will be appreciated that the fare batch may include a large number of rules, each rule containing numerous sequences and each sequence containing numerous categories. The simplified version shown above is provided by way of example only.

The updater then takes the XML document decodes it, step 46, generates a logical hierarchical tree structure of code generators, step 47, and then traverses the tree to generate the computer code. Each code generator in the updater 34 is an object, each one relating to one tag of the fare batch, e.g. the rule, sequence, category or the like. Each object has a generate code method which can take a portion of the XML code and generate the required programming code for storage in the database 12.

The code generators are arranged in a tree structure 51 shown in FIG. 5 which logically shows the manner in which the XML data is processed to generate the code. For example, first of all the category 3 object 53 generates code relating to the associated fare rule shown in the XML file step 48. This is then passed to the sequence object 52, step 49, which generates code step 50 in relation to the tags of the XML document. The code generated by the category 3 object is embedded in the sequence generated code where required. Similarly the rule object 55 generates code, step 50, relating to the XML data under the rule ID tag and embeds any code generated by the sequence object 52 in the required place. The final generated code shown where the portions of the code generated by each object are identified. There will be code generators objects for each tag that might exist in the XML, but only a small selection are shown in FIG. 5 for clarity. It will be appreciated that the generated code shown is provided by way of example only and is a simplified version. The actual generated code will longer and based on the XML data which contains many more elements. A typical example of XML data is shown in appendix A, with corresponding computer code shown in appendix B after conversion.

The computer code in the database 12 is generated from XML data defining the fare rules as described earlier. A separate portion of computer code is created for each fare rules. The computer code embodies the respective fare rule and can be compiled by the search/quote engine 5 and executed in order to process fare constructions and determine their validity or otherwise. Each fare construction may comprise several individual fares that enable the customer to reach their destination. For example where a customer wishes to travel from Invercargill to Los Angeles, they first require an internal domestic flight from Invercargill to Auckland, the international hub which corresponds to one fare, and then a second flight from Auckland to Los Angeles which relates to another fare. Various combinations of available fares between Invercargill and Auckland and then Auckland and Los Angeles may be put together, each combination forming a fare construction. The fares specify price options for price flights that a customer can take. Journey options relate to the actual physical flights available to take a customer to their desired journey. For any requested journey, there might be a number of different combinations of actual flights that could get the customer to their destination (and back again if relevant). Each journey option relates to one set of flight combinations that gets the customer to their destination (and back again), i.e. that provides their requested journey. Therefore, when a customer enters details requesting a journey to a destination (and/or return), the system first determines the journey options, each being a combination of flights that can take the customer to the destination (and back again if required). Then, the system determines for each journey option, one or more constructed fares, each comprising one or more fares. Each constructed fares define pricing options, for putting a purchase price to the journey option, should the customer wish to take it. Using the fares, the journey options can be priced. The constructed fare, however, might not be valid or applicable for a particular journey option. Therefore, this must be determined before the journey (i.e. the possible journey options) and possible price(s) for each journey option (specified by a constructed fare) is presented to the user. Note, a set of flights forming a journey option might not correlate directly to a fare or fares in the constructed fare. For example, a fare might specify the price option for a flight from city A to city B. The actual journey option might use two flights to get from city A to city B, the first going from city A to interim city C, and the second from city C to city B.

An example of possible fares for use in such a construction is shown below. It will be appreciated that in any one journey there may be a large number of individual fares that could be arranged in various combinations to form a number of fare constructions for a particular journey. It will be assumed that these relate to one journey option.

| | |
|---|---|
| 1 fare | akl-lax rt bus $5000 nzd 5001 |
| 2 add on | ivc-akl rt bus $50 nzd |
| 3 fare | akl-lax ow econ $2000 nzd 6001 |
| 4 fare | akl-lax ow econ $199 nzd 5001 |

Each fare in a fare construction will have an associated rule which is identified by a unique ID. This associated rule indicates which categories of rules must be satisfied in order for that particular fare to be validly offered as part of the fare construction. There are an international set of standard categories, as will be known to those skilled in the art. As described earlier, each category has a number of criteria that must be satisfied by the fare in order for the fare to satisfy the category. And the fare must satisfy each of the categories associated with it by the rule in order to be validly offered. The individual criteria specified under each category are maintained and specified by the airline in accordance with their requirements.

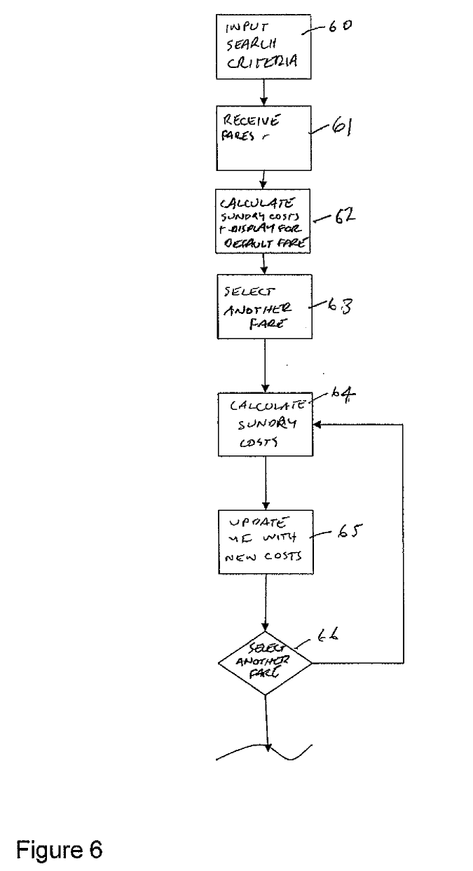

The search/quote engine 5 has category validator objects for each international standard category. The search/quote engine 5 processes fare constructions in the following manner. Referring to FIG. 6, it first obtains the fare construction for a journey option. It then processes each fare of that fare construction in turn. First, it identifies the rule associated with the fare. It then obtains computer code embodying the fare rule associated with the fare from the database 12, step 60, and then obtains all other necessary data to process fare constructions, such as the fare, party details, itinerary, journey options and the like, step 61. The computer code for a rule might specify several categories which define requirements the fare must satisfy to be valid. This might relate to various factors, such as date of travel, the actual physical flights of the journey options, and other factors. For a fare in a fare construction the code calls and applies all the category validators in turn, step 62, relating to the categories it must satisfy as identified by the rule. For example in relation to the fare between Auckland and Los Angeles with the rule ID 5001, the fare might have to satisfy categories 3 and 16. As the generated fare rule code is executed, the category 3 validator is called to validate the fare. Various information (input criteria) is passed to the validator object such as the constructed fare, the itinerary, the party information, journey option and the like and other information required in order to process the fare rules. The validator then validates the particular input criteria (i.e. sees if all specified requirements are met) to determine whether the fare satisfies the category. A small example of the generated code which calls the category 3 validator is shown below.

If (fare basis =”TAM1Y” and flying “NZ” to “US”)

(if not

Validate Cat 3 (“1DEC”,”31DEC”)
Return false

)
Return true

To satisfy the category the flight between New Zealand and the US must occur between 1 December and 31 December. If the input itinerary of the customer satisfies that query, then the validator returns a match which indicates that the fare meets that category, step 63. If not, step 64, the fare is discarded as invalid and the next fare is processed, step 66. The next validator is then called by the computer code for the fare rule. A similar process is carried out with a category 14 validator, step 65, 62, 63, and if that also returns a match the fare is indicated as being valid. The engine then moves on to the next fare in the set of constructed fares, and determines if it's valid for the input criteria. This is done for all fares of a constructed fare. If all fares are valid, then the entire constructed fare is valid for the journey options, and it could be presented to the customer. An entire constructed fare is usually processed together, rather than the individual components, as whether or not a constructed fare meets the requirements may be dependant of the relationship between the individual fares of the construction. If a constructed fare meets all the requirements then it is flagged as valid and can be presented to the user, step 67. All other constructed fares are also processed in the same manner, step 66, for all other journey options. Note, a journey option might have several possible constructed fares, none, some or all of which might be valid for that journey option. If none are valid, then the journey options cannot be presented to the user, because there are no valid fares for that journey option.

Generating efficient computer code from fare rules enables the constructed fares to be processed much more quickly than if this was done on the raw fare rule data. The compiled computer code works more efficiently, than if the raw fare rules were interpreted on the fly each time they had to be processed. In one embodiment, the first time a fare rule is used, the computer code is generated and compiled and used. The next time that fare rule is required, the already compiled computer code is reused.

Providing and Updating Sundry Costs

A further embodiment of the invention will be described with reference to FIGS. 6-10. At least one embodiment of the invention overcomes drawbacks of existing booking systems. The total price of the fare that is presented by a booking system includes the actual cost of the flight itself, along with added sundry costs which might be things like airport taxes, levies, surcharges and the like. Sundry costs are not fixed and are dependant upon many factors such as the airports used and the number of flights taken in a particular itinerary. Therefore, when flying from one point to a destination the sundry costs may differ depending on how the fare is constructed. Typically, when a range of constructed fares are presented to a user it is difficult or extremely process intensive to calculate the sundry costs for every constructed fare. Therefore, to overcome this, existing booking systems do not show the sundry costs in the initial stages, but rather just show the actual flight cost for each of the fare constructions presented to the customer. When the customer selects a desired flight which they wish to book, the booking system then calculates the sundry cost for that particular fare construction and adds it to the cost of the actual flights comprising the fare construction in order to provide a final price. This method of proceeding is undesirable as it means the customer is not aware of the total price they will pay when they select any particular fare construction. Further, it is not even possible to provide a rough indication of what a sundry cost will be prior to actual calculation as they differ depending on various circumstances surrounding a particular fare construction.

The present embodiment of the invention provides the user with sundry costs for any selected fare construction prior to booking actually being undertaken. This allows the user to inspect the total cost for a range of selected fare constructions prior to committing to booking any particular one of those fare constructions. This provides an advantage over existing systems which only provide a final price including sundry costs when a commitment to book a particular flight is actually made.

FIG. 6 shows a flow chart indicating one method of how the customer obtains an indication of sundry costs prior to booking. The customer first inputs their journey search criteria, step 60, as described previously in relation to FIGS. 1 and 2, and the system constructs and presents a range of fare constructions to the user that meet that criteria in the manner described previously, step 61a. The system also determines a default selection of fare constructions from those presented and calculates the taxes and other sundry costs associated with that default selected fare construction, step 62. The user is therefore presented with the flights that meet their criteria along with the flight costs, and for one particular fare construction they are also provided with the sundry costs and an optional total figure, step 65.

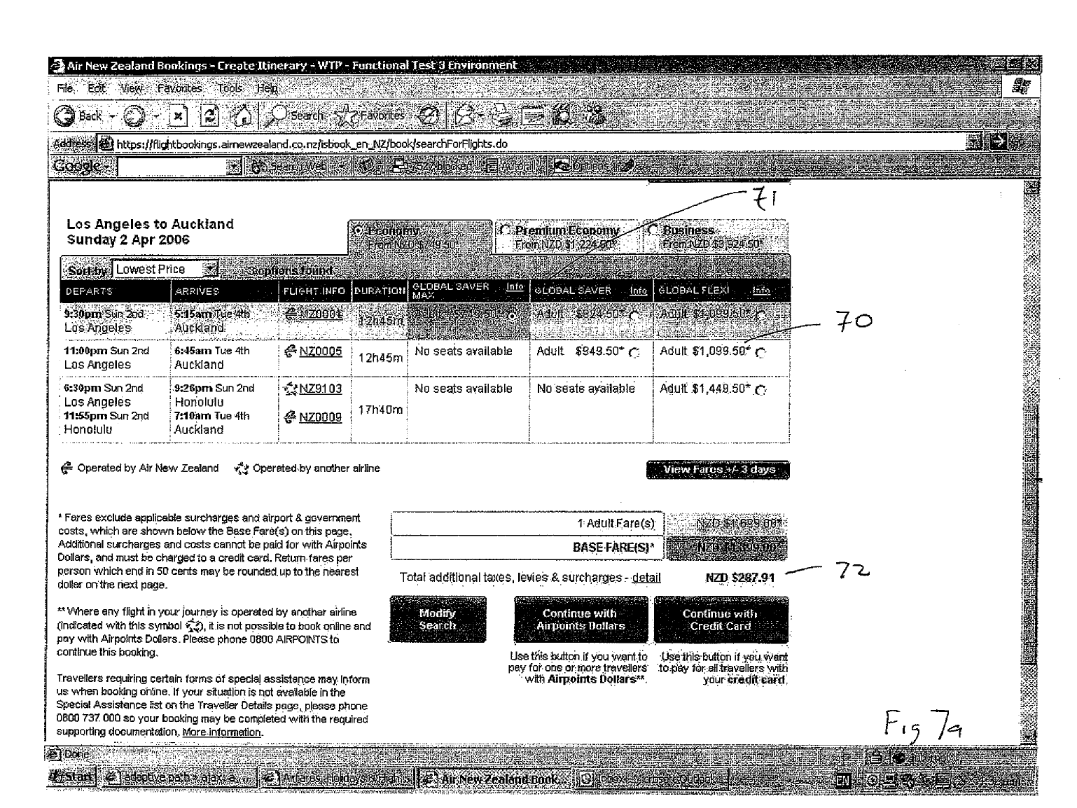

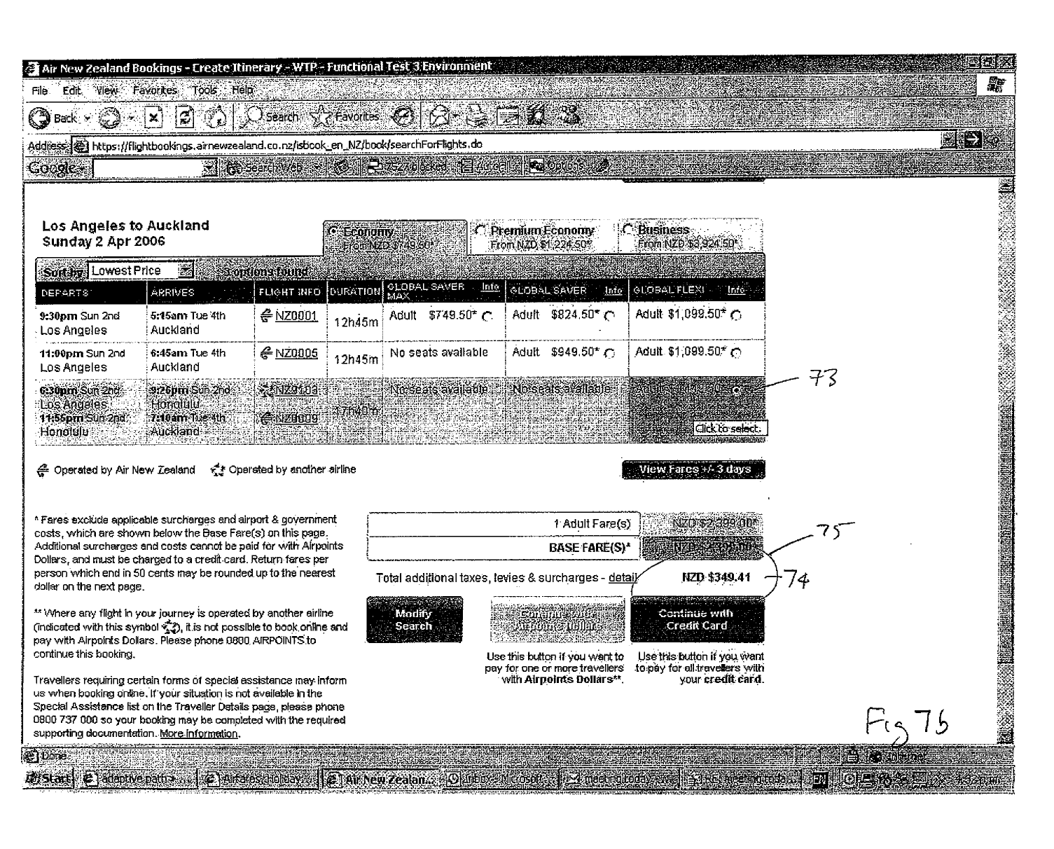

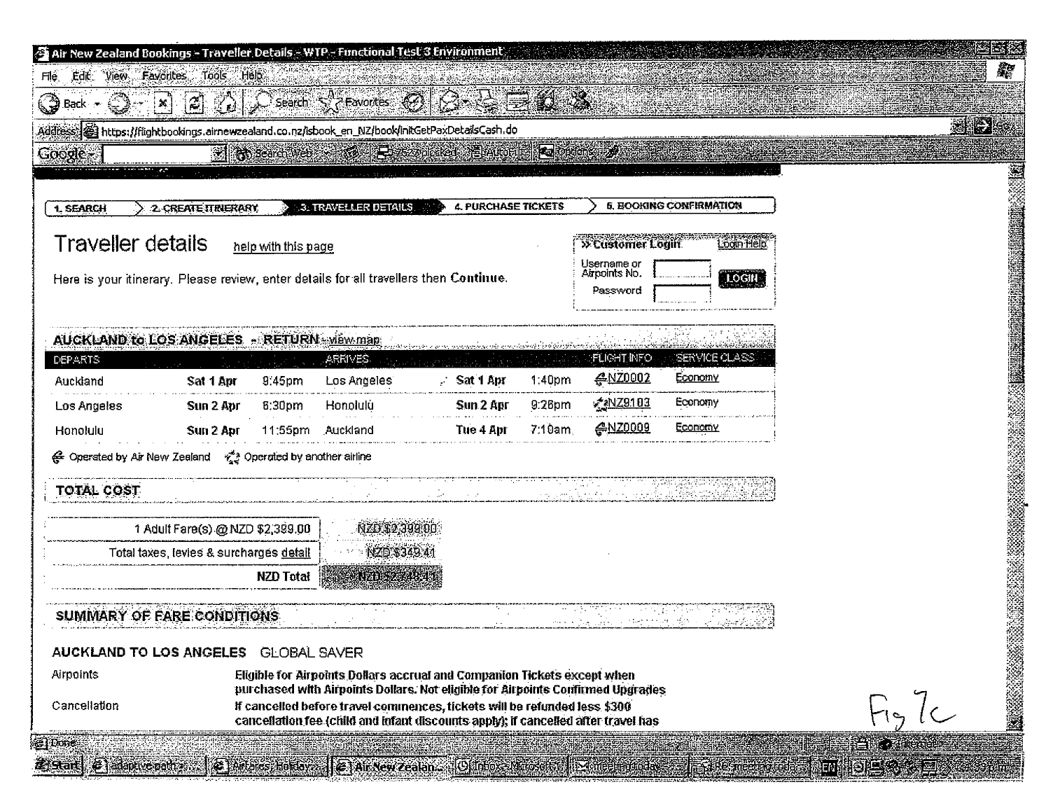

For example as shown in FIG. 7a, three fare constructions (each with multiple costs) are shown between Los Angeles and Auckland all including the actual flight cost, (e.g. 70). The default selected fare 71 also includes the calculated sundry cost 72. Referring back to FIG. 6, should a customer wish to find the total price for another fare they can select that fare, step 63, and they can obtain the sundry costs for it, step 64. For example referring to FIG. 7b, in this case the customer has selected the third fare construction 73, step 63, and the sundry costs associated with that fare construction are calculated, step 64, and displayed 74, step 65.

In one embodiment of the invention the presentation layer 14 or user interface presented to the user is not completely updated. Rather only the portion of the screen showing the sundry costs (e.g. 75) is updated showing the new sundry costs. This prevents the user having to wait for an entire web page to be downloaded and refreshed. However, it would be possible for the invention to work by refreshing the entire page. The user can continue to select other fare constructions, step 66, and by doing so receive the sundry costs associated with any fare construction and therefore the total price. This can continue until the user has viewed all the fare constructions including sundry costs or has found a fare that suits their requirements. It will be appreciated that the default sundry costing presented initial, step 62, is determined in the same manner as steps 64-65, except that a default fare is used, rather than the customer selecting a fare for sundry cost calculation.

After doing so the user can proceed to use the booking system 13 in the usual manner, for example booking an actual fare. In this case the user books the third fare construction by clicking the continue with credit card button and is provided with the full cost and itinerary on a booking page as shown in FIG. 7c. The processing continues in the usual manner. Note that while the full price is not shown in total in FIG. 7a or 7b it could do if required. Also note that in the final booking page, the final price may differ slightly from that presented in the fare construction selection pages, due to rounding processes which are standard in the art.

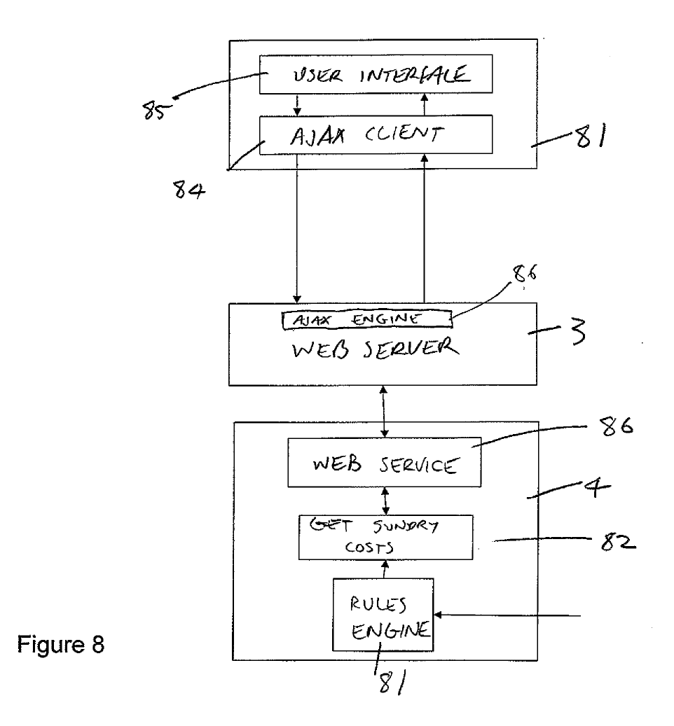

FIG. 8 shows a block diagram of the sundry costs calculation engine 6 and its interrelationship with the client application 80 on the customer's computer 1 via the web server 3. The structure of the software and its interrelationship with the client application enables calculation and presentation of fares and the associated sundry costs prior to actual booking of any particular fare. The engine 6 retrieves sundry cost data or information from the maintenance database 11. The maintenance database is kept up to date by personnel in the airline operating the system to provide the latest sundry costs, such as taxes, levies and surcharges as they are received from various sources. The sundry costs are known to those skilled in the art, and include things such as airport taxes, security taxes, fuel surcharges and other levies imposed by airports, governments and airlines. Depending on where a particular plane flies and lands, various sundry costs will be incurred in accordance with those stipulated by the airports and countries in which the flight lands or flies. The sundry costs maintenance database 11 includes information relating to the type of sundry costs that may need to be applied, the actual costs associated with it, and rules for determining whether or not the sundry costs should be applied in a particular circumstance. This information is retrieved by the sundry cost engine 6 and is passed to a rules engine 81 which determines which sundry costs should be applied. To do so it also receives the relevant information on the fare construction for which sundry costs are to be calculated and any other necessary information required to determine which sundry costs should be applied to those fare constructions. The rules engine 81 could be any suitable rules engine, such as DROOLS. An example of a tax/levy rule which might be applied is shown below.

<rule name=“Airport Security Charge - (EZ)”>

<parameter identifier=“segment”>

<class>Segment</class>

</parameter>
<java:condition>!segment.getTaxes( ).containsTax(“EZ”)</java:condition>
<java:condition>

port.getCountryForPort(segment.getDeparturePort( )).equals(“FJ”)

</java:condition>
<java:condition>

!port.getCountryForPort(segment.getArrivalPort( )).equals(“FJ”)

</java:condition>
<java:consequence>

System.out.println(“CON - Aiport Security Charge - (EZ)”);
segment.getTaxes( ).add(“EZ”,“Aiport Security Charge - (EZ)”, “FJD”,

5.0,

segment.getJourney( ).getAdultCount( ),0,0);

</java:consequence>

</rule>
<rule name=“Fuel Surcharge - NZ POS - NZ to AU/CK/FJ/NF/NC/PF/TO/WS -
(YQ)”>

<parameter identifier=“segment”>

<class>Segment</class>

</parameter>
<java:condition>!segment.getTaxes( ) .containsTax(“YQ”)</java:condition>
<java:condition>

segment.getJourney( ).getPosCountry( ).equals(“NZ”)

</java:condition>
<java:condition>

port.getCountryForPort(segment.getDeparturePort( )).equals(“NZ”)

</java:condition>

<java:condition>port.getCountryForPort(segment.getArrivalPort( )).equals(“AU
”) ||
port.getCountryForPort(segment.getArrivalPort( )).equals(“CK”) ||
port.getCountryForPort(segment.getArrivalPort( )).equals(“FJ”) ||
port.getCountryForPort(segment.getArrivalPort( )).equals(“NF”) ||
port.getCountryForPort(segment.getArrivalPort( )).equals(“NC”) ||
port.getCountryForPort(segment.getArrivalPort( )).equals(“PF”) ||
port.getCountryForPort(segment.getArrivalPort( )).equals(“TO”) ||
port.getCountryForPort(segment.getArrivalPort( )).equals(“WS”)

</java:condition>
<java:consequence>

System.out.println(“CON - Fuel Surcharge - NZ POS - NZ to

AU/CK/FJ/NF/NC/PF/TO/WS - (YQ)”);

segment.getTaxes( ).add(“YQ”,“Fuel Surcharge - NZ POS - NZ to

AU/CK/FJ/NF/NC/PF/TO/WS - (YQ) - Adults + Children”, “NZD”, 50.00,
segment.getJourney( ).getAdultCount( ), segment.getJourney( ).getChildCount( ),
0);

// taxes for infants
segment.getTaxes( ).add(“YQ”,“Fuel Surcharge - NZ POS - NZ to

AU/CK/FJ/NF/NC/PF/TO/WS - (YQ) - Infants”, “NZD”, 1.00,
0,0,segment.getJourney( ).getInfantCount( ));

drools.modifyObject(segment);

</java:consequence>

</rule>
<rule name=“Fuel Surcharge - NZ POS - International Sector - (YQ)”
salience=“−10”>

<parameter identifier=“segment”>

<class>Segment</class>

</parameter>
<java:condition>!segment.getTaxes( ).containsTax(“YQ”)</java:condition>

<java:condition>segment.getJourney( ).getPosCountry( ).equals(“NZ”)</java:con
dition>

<java:condition>

!port.getCountryForPort(segment.getArrivalPort( )).equals(“NZ”) ||
!port.getCountryForPort(segment.getDeparturePort( )).equals(“NZ”)

</java:condition>
<java:consequence>

System.out.println(“CON - Fuel Surcharge - NZ POS - International

Sector - (YQ)”);

segment.getTaxes( ).add(“YQ”,“Fuel Surcharge - NZ POS - International

Sector - (YQ) - Adults + Children”, “NZD”, 60.00,
segment.getJourney( ).getAdultCount( ), segment.getJourney( ).getChildCount( ),
0 );

drools.modifyObject(segment);

</java:consequence>

</rule>

It will be appreciated that other rules engines would employ other mechanisms for coding rules. This would be a set of rules obtained from the rules maintenance database and is implemented in the rules engine to determine whether or not it should be applied to a particular fare construction. The first rule is for a security charge that is imposed at Fiji airport. This is one rule of many that will be processed to determine whether it is relevant to the particular fare construction. First, this rule determines whether a security charge has already been applied to the fare construction. If not then determines whether the fare construction includes a flight which departs form Fiji airport, and then if so further determines that the traveler did not actually arrive by airline at Fiji airport. If all these conditions are met then the airport security charge is added as a sundry cost to the fare construction. If any of those conditions are not met, then the security charge is not added to the fare construction. In this case the charge is 5 Fijian dollars. An example of a fuel surcharge rule is also indicated above. The rules for sundry costs and the manner in which they are applied will be understood by those skilled in the art, and the rules shown above are therefore provided by way of example only. Once all the rules have been processed the GET SUNDRY COSTS method 82 applies the various sundry costs that have been determined to the fare construction price. This information is then passed through to the web server 3 via a web service 86 or similar.

As mentioned previously, in one embodiment of the invention when a sundry cost is returned for display to the user the web server does not refresh the entire fare construction presentation page. Rather it only refreshes the particular portions (e.g. 74) of the web page that display the costs, and updates these with the freshly updated costs. This is achieved through asynchronous internet transfer technologies, such as an AJAX implementation 84, 86 or any other suitable means. The AJAX implementation resides in the web server 86 and in the client application 80 where it is coupled with the user interface 85 operating on the client application 80. The AJAX implementation enables information to be transferred asynchronously between the booking system 13 and the browser client 80 and only update portions (e.g. 74) of the client interface as required. More particularly, the user interface displays constructed fares and when user selection is made to determine taxes for another fare construction a call is sent back to the booking system 13 via the AJAX implementation. While doing so the fares and prices already presented to the customer on the client application user interface remain on display. The AJAX client 84 then sends the request to the sundry cost engine 6 via the web server 3 and then receives the calculated costs as described previously. It then passes these costs onto the user interface layer 85 whereby the portions (e.g. 74) of the user interface that display sundry costs are updated with the new sundry costs that have been freshly calculated. At this point the portions of the screen that show the actual cost of the particular selected flight are also updated to show the costs of the newly selected flight relating to those sundry costs.

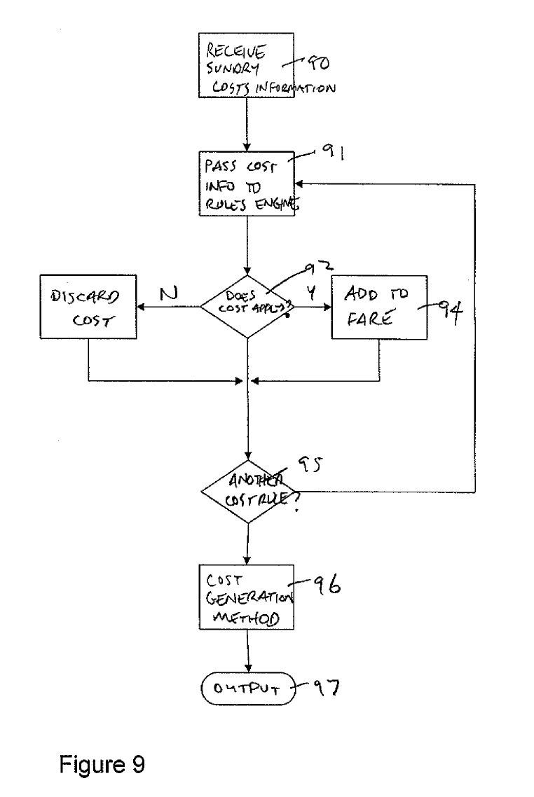

FIG. 9 shows how the sundry costs are actually processed in the rules engine 81. Firstly the sundry costs engine 6 receives the sundry costs information from the maintenance database 11 including types of costs, the value of those costs and rules for determining when to apply the costs step 90. These are then passed to the rules engine step 91 which carries out processing. In particular it retrieves each rule in turn such as that shown above and determines if it applies to the particular fare construction step 93. If it does, then the sundry cost is added to the total costs of the fare construction step 94, and the rules engine then determines if another sundry cost rule exists step 95 and if so that is processed in the same manner steps 92-95. Once all sundry cost rules have been processed the information is passed onto the sundry cost generation method, step 96, and these are all passed on to the web server for transfer to the client application 80, step 97.

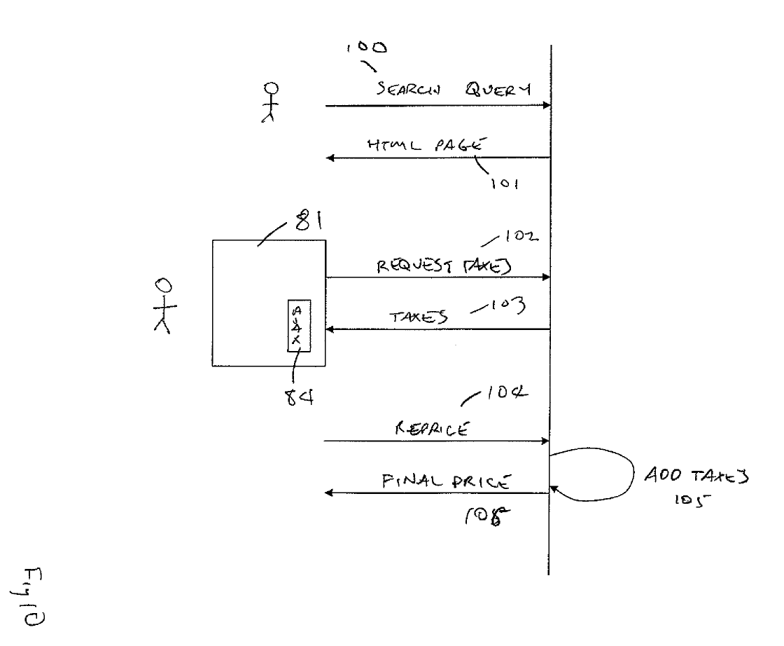

FIG. 10 shows a process diagram of how the system calculates these costs. First of all the user sends a search query 100, and receives back a page of HTML or similar 101 including fares. The customer then operates the client application 81 to request taxes 102 or other sundry costs, and these are calculated and passed back by the system 13 via the AJAX implementation where they are displayed on the client application 81. Upon booking, the system then does a repricing 104 where it adds sundry costs 105 and also rounds the cost appropriately. The final price 106 is passed to the customer and displayed.

Using Multiple Tabs to Display Fares

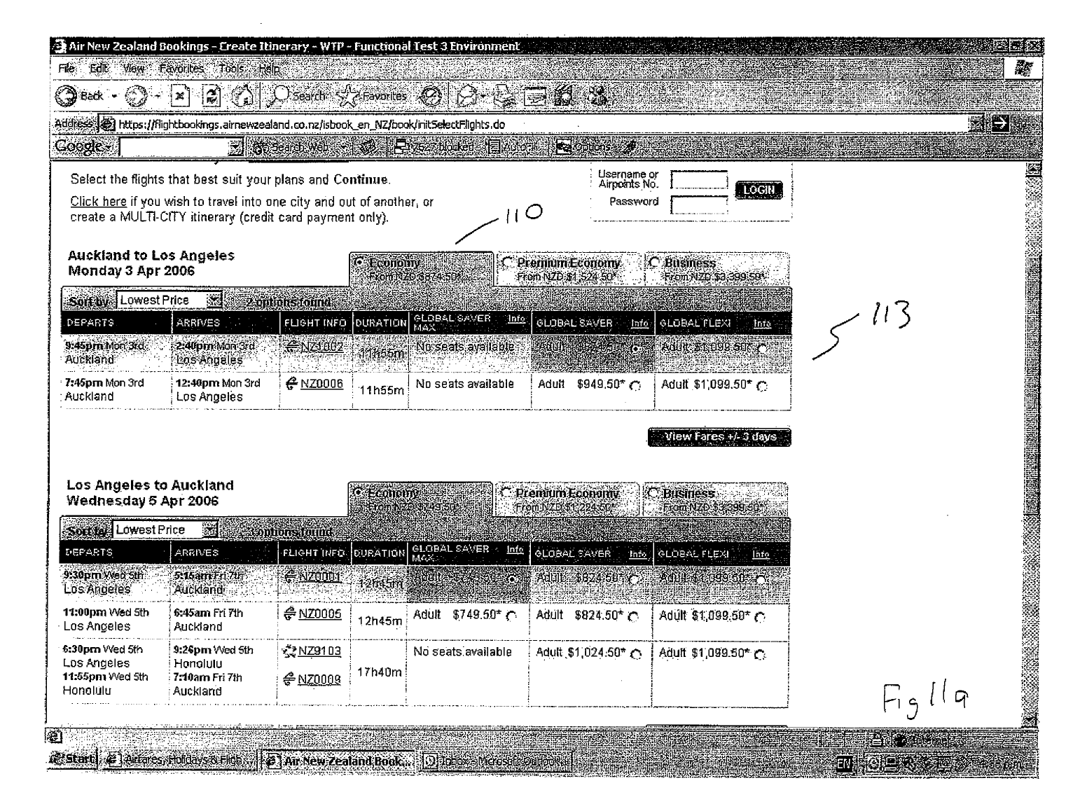

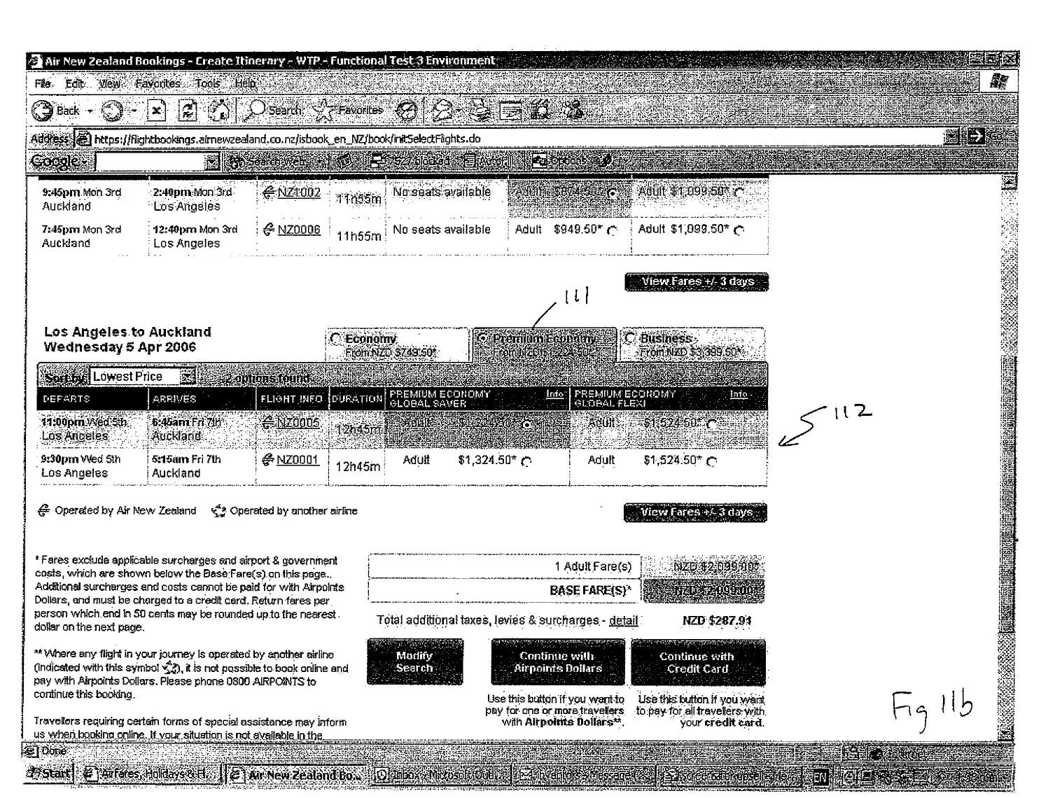

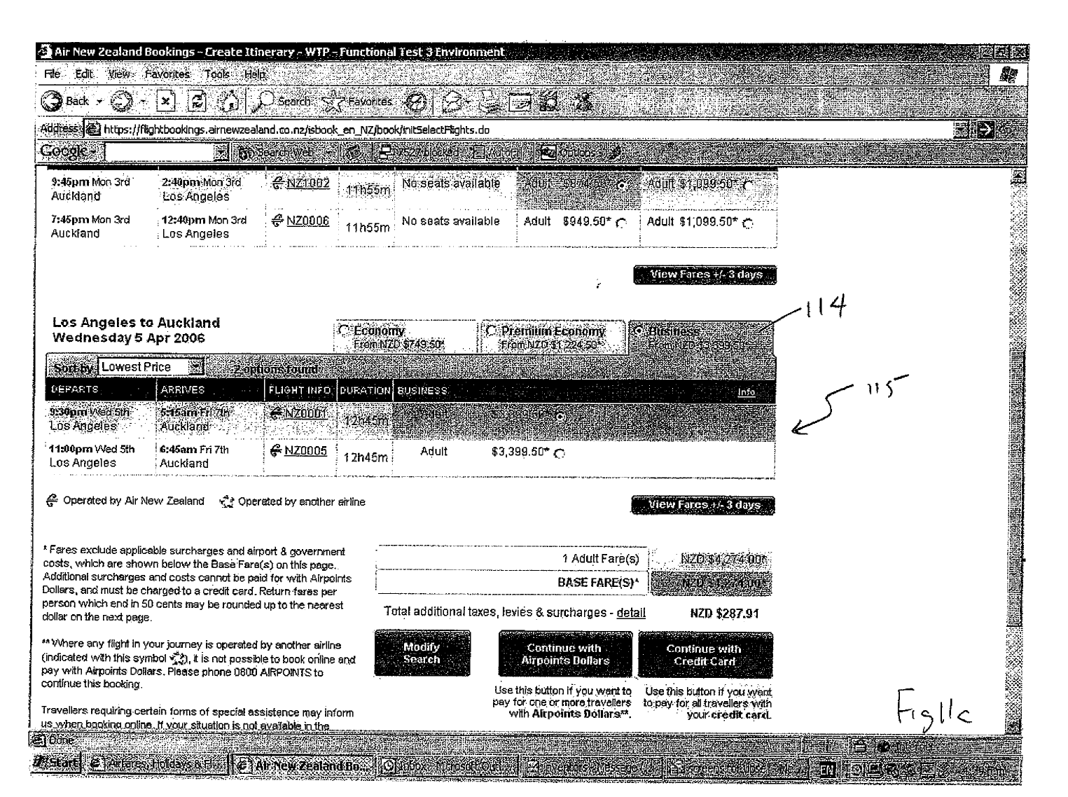

In one embodiment of the invention, the booking system 13 provides the customer with fares in multiple classes in response to the query, as will be described with reference to FIGS. 11a-11d.

As described in relation to the flow chart in FIG. 2, the customer can enter various criteria indicating the type of flight they require for travel. The booking system 13 then returns a set of possible flights satisfying the criteria that are displayed to the user for inspection, and booking. As part of the criteria, the customer may specify a class of travel, such as service class. For example the class may be first class, business class, economy class, premium economy or any other class of travel provided by the airline. Generally the customer will select a certain class based on the budget they have for travel, their travel requirements and their desired level of comfort they require during travel. For example, if a customer is more concerned with cost they are likely to select economy class as this will generally provide cheaper fares for any particular flight, although with a reduced level of service.

In existing booking systems, the booking system will only return fares that correspond to the class selected by the traveler. However, in this embodiment of the present invention the booking system 13 will provide fares of other classes that otherwise meet the customer's flight requirement. This provides the airline with the ability to up-sell a better class and higher price of flight to the customer.

This embodiment of the invention works in the following way. Once a customer enters their travel criteria, the booking system will determine all the fares that meet the criteria in the usual way as explained previously. This will include ensuring that any flights meet the class criteria entered by the customer. However, in this embodiment of the invention the system will also determine flights for other classes not selected by the customer, but that meet all other criteria (apart from class) selected by the customer. This information is passed to the presentation layer 14 on the web server 3. The presentation layer then generates a graphical user interface which displays all the fares for all the classes to the user FIGS. 11a-11c. However, the fares for a particular class are shown in separate tabs, and the user can select the tab of the class for which they wish to view the available fares. For example with reference to FIG. 11a in this case the customer has requested economy class flights between Auckland and Los Angeles. The 113 flights meeting that criteria are displayed to the user in a screen with a tab indicated economy 110. However the system has also determined flights which meet the same criteria for premium economy and business class. These fares are hidden from view initially but are contained in tabs that can be selected by the user.

For example, referring to FIG. 11b the user has selected the premium economy class tab 111 and in doing so is presented with a range of flights 112 in premium economy that meet their criteria. Similarly, in FIG. 11c the user has selected the business class tab 114 and in doing so is presented with all flights 115 meeting the criteria that fall within business class. In this way the user can be presented with flights of other classes that fall within their other criteria they have selected. Where a customer selects another class as their criteria, for example premium economy then economy and business class will be shown. Where business class is selected as a criteria in the initial search, economy and premium economy classes will also be provided. It will be understood by those skilled in the art that this embodiment of the invention could be applied to other classes of travel. It will also be appreciated that this presentation of fares in tabs representing each class could also be provided where a user does not select a desired class of travel at all.

While in at least one embodiment all classes of travel are determined together when processing the user's search query, alternatively they could be determined as and when a user selects a tab relating to a particular class.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

1. A method of determining fares for display to a user using a booking system comprising:
converting fare rules into a computer code;
storing the computer code;
receiving flight criteria from a user;
identifying candidate fares satisfying the flight criteria received from the user; and
retrieving and executing the computer code to determine which of the candidate fares satisfy the fare rules embodied by the computer code.

2. A method according to claim 1, wherein the fares comprise one or more associated costs for purchasing/booking a journey.

3. A method according to claim 2, wherein the converting comprises:
retrieving data defining fare rules;
generating interim code that defines the fare rules; and
from the interim code, generating the computer code, the computer code defining the fare rules.

4. A method according to claim 3, wherein the computer code is compiled.

5. A method according to claim 1, wherein the executing comprises:
selecting a candidate fare;
identifying a fare rule to be applied to the selected candidate fare;
obtaining and executing computer code defining the fare rule;
obtaining information for applying the fare rule; and
executing a validator specified by the computer code, the validator utilizing the obtained information on the candidate fare to determine whether or not the candidate fare satisfies a fare rule defined by the computer code.

6. A method according to claim 5, wherein each fare ruled defined by the computer code has two or more categories, wherein a validator applies each category, and wherein the method further comprises:
executing one or more further validators specified by the computer code;
the one or more further validators utilizing the obtained information on the candidate fare to determine whether or not the candidate fare satisfies one or more fare rules defined by the computer code; and
identifying the candidate fare as one that is valid.

7. A method according to claim 6, further comprising:
selecting a further candidate fare;
retrieving information on the further candidate fare;
executing one or more validators specified by the computer code, each validator utilizing the obtained information on the further candidate fare to determine whether or not the candidate fare satisfies one or more fare rules defined by the computer code; and
identifying the further candidate fare as one that is valid.

8. A method according to claim 7, wherein the candidate fares relate a constructed fare, and if all candidate fares are valid, the constructed fare is flagged as one possible to present to a user.

9. A method according to claim 3, wherein the interim code defines one or more fares rules, and contains identifiers that identify portions of the interim code that specify a fare rule and aspects of that fare rule, the generating the computer code from the interim code, wherein the method further comprises:
parsing the interim code;
generating a hierarchy of code generators relating to the portions of the interim code identified by the identifiers; and
executing each code generator to generate computer code relating to the portion of the interim code to which the code generator relates, wherein each code generator at a higher level in the hierarchy utilizes code generated by a code generator directly below in the hierarchy.

10. A method according to claim 3, wherein the interim code defines one or more fares rules, and contains identifiers that identify portions of the interim code that specify a fare rule and aspects of that fare rule, the generating the computer code from the interim code uses one or more code generation processes to, each process generating a subset of the computer code from a subset of the interim code, wherein each code generation process is assigned a logical position in a hierarchy, wherein the computer code generated by a lower code generation process in the hierarchy is passed to a higher code generation process in the hierarchy, and wherein when generating computer code, the higher code generation process utilizes the code generated by the lower code generation process.

11. A method according to claim 10, wherein interim code data defines fare rules comprising a number of categories, each of which comprises criteria and wherein a code generation process is used for each category, which can extract data from the interim code relating to that category, and generate computer code from that data.

12. A method according to claim 11, wherein the hierarchy is a tree structure of code generation processes, and the tree structure is traversed in order to generate code with the code generation processes.

13. A method of generating code defining fare rules for determining fares available for display to a user using a booking system, comprising:
retrieving data defining fare rules;
generating interim code that defines the fare rules, wherein the interim code defines one or more fares rules, and contains identifiers that identify portions of the interim code that specify a fare rule and aspects of that fare rule;
parsing the interim code;
generating a hierarchy of code generators relating to the portions of the interim code identified by the identifiers; and
executing each code generator to generate a computer code relating to the portion of the interim code to which the code generator relates, wherein each code generator at a higher level in the hierarchy utilizes code generated by a code generator directly below in the hierarchy.

14. A method according to claim 3, wherein the obtained information is one or more of:
journey option(s) related to the candidate fare; and
itinerary information relating to the candidate fare.

15. A method according to claim 1, wherein the method is executed at least partially in an airline booking system.

16. A method according to claim 1, wherein a candidate fare is or forms part of a fare construction.

17. A method of identifying and presenting fares to a user, the method comprising:
receiving flight criteria specified by a user;
receiving computer code from a database, the computer code being generated from fare rules to embody the fare rules;
selecting candidate fares satisfying the flight criteria received from the user;
executing the computer code to determine which of the candidate fares that satisfy the fare rules embodied by the computer code; and
presenting the relevant candidate fares that satisfy the fare rules to a user.

18. A computer system adapted to generate a code defining fare rules for determining fares available for display to a user using a booking system, the computer system comprising:
a database containing data defining fare rules;
a first code generator module connected to the database and adapted to retrieve data from the database and generate interim code defining fare rules; and
a second code generator module connected to retrieve interim code from the first code generator, the second code generator adapted to generate computer code from the interim code, the computer code defining the fare rules.

19. A computer system according to claim 18, wherein the interim code defines one or more fares rules, and contains identifiers that identify portions of the interim code that specify a fare rule and aspects of that fare rule, and wherein the second code generator module is adapted to:
parse the interim code;
generate a hierarchy of code generators relating to the portions of the interim code identified by the identifiers; and
operate each code generator to generate a computer code relating to the portion of the interim code to which the code generator relates, wherein each code generator at a higher level in the hierarchy utilizes code generated by a code generator directly below in the hierarchy.

20. A computer system according to claim 18, wherein the interim code defines one or more fares rules, and contains identifiers that identify portions of the interim code that specify a fare rule and aspects of that fare rule, and wherein the second code generator module comprises one or more code generators, each code generator being adapted to generate a subset of the computer code from a subset of the interim code, wherein each code generator is assigned a logical position in a hierarchy, wherein the computer code generated by a lower code generator in the hierarchy is passed to a higher code generator in the hierarchy, and wherein when generating computer code, the higher code generator utilizes the code generated by the lower code generator.

21. A computer system according to claim 20, wherein interim code data defines fare rules comprising a number of categories, each of which comprises criteria and wherein the second code generator module comprises a code generator for each category, each of which can extract data from the interim code relating to that category, and generate computer code from that data.

22. A computer system according to claim 11, wherein the hierarchy is a tree structure of code generators, and the tree structure is traversed in order to generate code with the code generators.

23. A computer system according to claim 18, wherein the computer code is stored in the database and the computer system further comprises:
a search engine connected to the database, wherein the search engine adapted to receive flight criteria specified by a user and identify candidate fares satisfying the flight criteria, and wherein the search engine can execute the computer code to determine which of the candidate fares satisfy the fare rules embodied by the computer code.

24. A computer system according to claim 18, wherein the search engine comprises one or more validators to execute the computer code to determine which of the candidate fares satisfy the fare rules embodied by the computer code, the search engine is adapted to:
select a candidate fare based on received user criteria;
identify a fare rule to be applied to the selected candidate fare;
obtain and execute the computer code defining the fare rule;
obtain information for applying the fare rule; and
execute one or more validators specified by the computer code, each validator utilizing the obtained information on the candidate fare to determine whether or not the candidate fare satisfies a fare rule defined by the computer code.

25. A computer system according to claim 18, wherein the fares comprise one or more associated costs for purchasing/booking a journey.

26. A computer system according to claim 18, wherein the computer code is compiled.

27. A computer system according to claim 18, wherein the interim code is a markup language.

28. A computer system according to claim 18, wherein the computer code is java code.

29. A computer system according to claim 18, wherein the computer system is or is integrated with an airline booking system.

30. A computer system according to claim 18, wherein a candidate fare is or forms part of a fare construction.

31. A booking system comprising a computer system adapted to receive flight criteria from a user, the computer system comprising i) a processor configured to convert fare rules into a computer code, ii) a memory configured to store the computer code, and iii) a computer program, running on the computer system, configured to operate the computer system to:
select candidate fares satisfying the flight criteria received from the user; and
retrieve and execute the computer code to determine which of the candidate fares that satisfy the fare rules embodied by the computer code.

32. A method of providing sundry costs to a user operating a booking system comprising:
receiving an input specifying flight criteria from a user;
identifying fares satisfying the flight criteria;
calculating sundry costs for a journey from sundry costs data retrieved from a database;
displaying information identifying the journeys and associated fares on a first sub-portion of a user interface and displaying the sundry costs for the journey on a second sub-portion of the user interface;
receiving an input selecting another journey; and
updating the second sub-portion of the user interface to display the sundry costs for the selected candidate fare.

33. A method according to claim 32, wherein the updating comprises calculating sundry costs related to the selected journey from data retrieved from the database.

34. A method according to claim 32, wherein the sundry costs can be one or more of taxes, levies and surcharges.

35. A method according to claim 32, further comprising displaying a total journey price comprising the associated fare for a selected journey and the displayed sundry costs for that journey.

36. A method according to claim 32, wherein when updating the second sub-portion of the user interface to display the sundry costs for the selected journey, the method further comprises updating the user interface to display a total cost comprising the fare associated with a selected journey and the displayed sundry costs for that journey.

37. A method according to claim 32, further comprising the updating the database with data for calculating sundry costs.

38. A booking system comprising:
a computer system adapted to receive flight criteria from a user;
one or more databases containing fare information and data for calculating sundry costs;
a search engine adapted to identify fares satisfying the flight criteria received from the user;
a user interface adapted to display those fares to the user,
wherein the user interface is adapted to display information identifying a journey and associated fares on a first sub-portion of a user interface and displaying the sundry costs on a second sub-portion of the user interface, and
wherein the computer system is further adapted to receive input specifying a selected fare displayed on the first sub-portions and the user interface is adapted to update the second sub-portion of the user interface to display the sundry costs for the journey associated with the selected fare.

39. A booking system according to claim 38, wherein, when updating the second sub-portion of the user interface, the search engine calculates sundry costs related to the journey from data retrieved from the database.

40. A booking system according to claim 38, wherein the sundry costs comprise one or more of taxes, levies and surcharges.

41. A booking system according to claim 38, wherein the user interface is further adapted to display a total journey price comprising the fare associated with a selected journey and the displayed sundry costs for that journey.

42. A booking system according to claim 38, wherein when updating the second sub-portion of the user interface to display the sundry costs for the selected journey, the user interface is further adapted to update the user interface to display a total journey price comprising the fare associated with a selected journey and the displayed sundry costs for that fare.

43. A booking system comprising a computer system configured to receive flight criteria from a user, a computer program configured to select all fares satisfying the flight criteria received from the user, a user interface configured to display those fares to the user, and display for at least one fare, the cost of the flight associated with the fare and any sundry costs, a processor adapted to receive an input identifying another fare, obtain sundry costs for that fare and transfer the sundry costs to the user interface, wherein user interface is updated to display the sundry costs.

44. A user interface for a booking system comprising:
a portion adapted to display fares to a user that satisfy flight criteria received from the user, the portion comprising a sub-portion adapted to display the cost of the flight associated with the fare and another sub-portion adapted to display sundry costs,
wherein the user interface is adapted to display for at least one fare, the cost of the flight associated with the fare and any sundry costs in the respective sub-portions, and wherein the sub-portion adapted to display sundry costs can be updated with new sundry costs independently from other sub-portions of the user interface.

45. A method of displaying fares to a customer using a booking system, comprising:
receiving flight criteria from a customer;
determining all fares satisfying the flight criteria received from the customer; and
displaying those fares to the customer via a user interface, including for at least one fare, the cost of the flight associated with the fare and any sundry costs.

45. A method of providing sundry costs to a user of a booking system comprising:
maintaining a database with sundry cost data;
receiving a request for sundry costs for a journey;
obtaining sundry cost data from the database;
calculating sundry costs using the sundry cost data and a rules engine; and
presenting the sundry costs to a user.

46. A system for determining fares for display to a user using a booking system comprising:
means for converting fare rules into a computer code;
means for storing the computer code;
means for receiving flight criteria from a user;
means for identifying candidate fares satisfying the flight criteria received from the user; and
means for retrieving and executing the computer code to determine which of the candidate fares satisfy the fare rules embodied by the computer code.
